(19) United States
(12) Patent Application Publication
(10) Pub. No.: US 2003/0119560 A1
(43) Pub. Date: Jun. 26, 2003

(54) Radio communication control station device and radio communication device

(76) Inventors: Sunao Takatori, Tokyo (JP); Hisanori Kiyomatsu, Tokyo (JP)

Correspondence Address: Darby & Darby, 805 Third Avenue, New York, NY, 10022, US

(21) Appl. No.: 10/204,335

(22) PCT Filed: Dec. 25, 2001
(86) PCT No.: PCT/JP01/11393

(51) Int. Cl. H04B 1/00

(52) U.S. Cl. 455/564; 455/556; 455/426; 455/550

(57) ABSTRACT

A plurality of cellular base stations BS (BS1, BS2, BS3), a pager base station 13k, and a plurality of groups G1, G2, G3, G4, and G5 of portable communication terminals are provided in one pager communication system area Ak. Each of the portable communication terminals includes a cellular radio unit and a pager receiver. In each group, a plurality of portable communication terminals 1 are included, and use the same telephone line. Cellular radio units of portable communication terminals use a same telephone line, and the pager receivers use a same pager communication line. The portable communication terminals 1 have IDs different from each other. When any one of the portable communication terminals 1 starts communication, location information of the portable communication terminal is registered in a VLR. Moreover, when another portable communication terminal 1 in the same group intends to start communication, location registration thereof is rejected.

### TECHNICAL FIELD

The present invention relates to a radio communication control station apparatus and a radio communication device.

### BACKGROUND ART

In a mobile communication system such as personal digital cellular (PDC), two databases of a visitor location register (VLR) for registering locations of mobile communication terminals and a home location register (HLR) for registering user accounting information or the like are provided, and each of the mobile communication terminals is managed based on these databases. Costs for the management of user information are incurred regardless of frequency of use and are reflected to so-called basic charges, which is uneconomic for a user who does not frequently use the mobile communication terminal.

On the other hand, a pager communication system (radio calling system, pocket bell®) capable of sending short messages covers the widest area among the mobile communication systems. Regarding a service area of the pager communication system, services for a wide range of area such as a wide area service and a multi area service are performed starting from a local service roughly for each prefecture. In the service area of the pager communication system, one pager central station and a plurality of pager base stations are usually arranged. When a caller dials a calling number of a pager receiver (radio calling receiver), the caller is connected to a pager apparatus in the pager central station. The pager apparatus transmits an address signal for identifying the corresponding pager receiver and an inputted message signal to each of the pager base stations. The signal transmitted to each of the pager base stations is converted to a radio signal, and simultaneously transmitted at the same radio frequency from each of the base stations. When the pager receiver finds its own address signal in the received selective incoming call signal, the pager receiver rings, decodes the message signal, and displays contents thereof.

In order to reduce power consumption of the receiver, intermittent reception is performed. In the pager communication system, high intermittent reception ratio is realized, and the power consumption thereof is very low.

However, rapid spread of the cellular communication system causes the number of users of the pager communication system to greatly decrease in recent years, and the infrastructure thereof is not efficiently used.

In the pager communication system, since the pager receiver does not have a transmission mechanism, the user needs to perform location registration. When the user moves between areas, the user calls a registration representative number by means of a telephone, and inputs his/her own calling number and the number of an area to which the user wants to move, so that area information of a transfer destination is stored in the central station.

Here, explanation will be made on a basic signaling function of a mobile phone (portable communication terminal) in the cellular communication system with reference to a transition diagram of an operational state of FIG. 17.

When the power supply of the portable communication terminal is tuned on in step 151, location registration 152 is performed. Here, the portable communication terminal is registered in a network side so that calling for incoming call can be performed from the network side wherever the portable communication terminal is located. When location (area) information broadcasted via a broadcast channel is changed, the portable communication terminal performs the location registration.

After the location registration 152, the portable communication terminal is shifted to a standby mode 153. In the cellular communication system, a paging channel (PCH: simultaneous calling channel) is provided, so that, in the standby mode 153, the portable communication terminal performs the intermittent reception in synchronization with the simultaneous calling channel to which the portable communication terminal belongs. A power supply of a radio unit is turned off during a period of no reception of the simultaneous calling channel, thereby reducing power consumption.

When the portable communication terminal makes an outgoing call by an operation of a start button or the like, the portable communication terminal is shifted to an incoming call mode 154. Here, the portable communication terminal transmits an outgoing call signal to the base station. The portable communication terminal is then assigned a speech channel and shifted to a speech mode 156 for communication. Moreover, in receiving an incoming call signal via the simultaneous calling channel, the portable communication terminal is switched into an incoming call mode 155, and responds to the incoming call. The portable communication terminal is then shifted to the assigned speech channel and is switched into a communication mode 156. When the portable communication terminal moves between cells while speaking, channel switching 157 is performed. When speaking is terminated, the portable communication terminal performs disconnection 158, and returns to the standby mode 153.

In recent years, users of portable terminals such as PDC and a cellular mobile communication terminal are drastically increased. Sometimes, one family possesses a plurality of portable communication terminals. For example, in some cases, each member of the family has his/her own portable communication terminal. In such a case, the user must make a contract with a telecommunications business company and pay for a basic charge every month for each portable communication terminal. Among the members of the family, some members frequently use the portable communication terminals, and other members do not frequently use the portable communication terminals. Accordingly, it is a problem from an economical viewpoint that the basic charges are paid for all the portable communication terminals.

An object of the present invention is to provide a radio communication control station apparatus and a radio communication device, capable of relieving burden of expenses for the basic charge of a user who does not frequently use the portable communication terminal and capable of efficiently utilizing a pager communication system.

### DISCLOSURE OF INVENTION

A radio communication control station apparatus according to the present invention, comprises:

a memory for storing cellular telephone numbers of cellular radio units of a plurality of grouped radio communication devices together with respectively corresponding pager numbers of pager receivers;

pager calling means for calling a pager receiver for incoming call to the corresponding cellular telephone number stored in the memory; and

cellular calling means for calling a cellular radio unit of the cellular telephone number after the calling by the pager calling means.

In the radio communication control station apparatus according to the present invention, the memory stores the identical cellular telephone numbers and the identical pager numbers assigned for the plurality of radio communication devices in one group.

In the radio communication control station apparatus according to the present invention, the memory stores the different cellular telephone numbers and the identical pager numbers assigned for the plurality of radio communication devices in one group.

In the radio communication control station apparatus according to the present invention, the memory stores the identical cellular telephone numbers and the different pager numbers assigned for the plurality of radio communication devices in one group.

In the radio communication control station apparatus according to the present invention, the memory stores the different cellular telephone numbers and the different pager numbers assigned for the plurality of radio communication devices in one group.

The radio communication control station apparatus according to the present invention, further comprises:

location registration means for registering location information of one of the cellular radio units being grouped and stored in the memory, when an outgoing call to or an incoming call from the cellular radio unit occurs, and when the location information of another cellular radio unit in a group to which the cellular radio unit belongs is not registered.

In the radio communication control station apparatus according to the present invention, said location registration means deletes registration of the location information when communication of the cellular radio unit is terminated.

In the radio communication control station apparatus according to the present invention, in a state that location information has been registered by the location registration means, when an incoming call to or an outgoing call from another cellular radio unit in a same group occurs, the pager calling means notifies the cellular radio unit of which location information is registered of the occurrence of the incoming call or the outgoing call.

In the radio communication control station apparatus according to present invention, for one particular cellular radio unit (hereinafter, referred to as a preferential terminal) in the group, the location registration means retains registration of the location information until a power supply thereof is turned off after communication is terminated, and for the other cellular radio units (hereinafter, referred to as a non-preferential terminal), the location registration means deletes registration of the location information when the communication is terminated.

In the radio communication control station apparatus according to the present invention, when an incoming call to or an outgoing call from the non-preferential terminal is received, the pager calling means notifies the preferential terminal of the incoming call or the outgoing call.

According to the present invention, plurality of radio communication devices have cellular radio units and pager receivers mounted thereon, wherein the cellular radio units have a same cellular telephone number, alternatively the pager receivers have a same pager number.

### BRIEF DESCRIPTION OF DRAWINGS

FIG. 1 is a view showing a schematic constitution of a radio communication device (portable communication terminal) of the present invention.

FIG. 2 is a view illustrating a communication system including a radio communication control station apparatus of the present invention.

FIG. 3 is a view showing one pager communication system area of a radio communication system of the present invention.

FIG. 4 is a view showing a first example of a database of HLR.

FIG. 5 is a view showing a first example of a database of HLR.

FIG. 6 is a view showing a first example of a database of HLR.

FIG. 7 is a view showing a first example of a database of HLR.

FIG. 8 is an explanatory view for illustrating the operation of the radio communication control station apparatus of the present invention.

FIG. 9 is an explanatory view for illustrating the operation of the radio communication control station apparatus of the present invention.

FIG. 10 is a transition diagram of the operational state for illustrating the operation of the radio communication device of the present invention.

FIG. 11 is a transition diagram of the operational state for illustrating a modified example of the operation of the radio communication device of the present invention.

FIG. 12 is a view for illustrating the operation of the radio communication control station apparatus of the present invention.

FIG. 13 is a view for illustrating another example of the operation of the radio communication control station apparatus of the present invention.

FIG. 14 is a view for illustrating telephone directory information stored in the radio communication device (portable communication terminal) of the present invention.

FIG. 15 is a flowchart for explaining the operation of the radio communication device (portable communication terminal) of the present invention.

FIG. 16 is a block diagram showing a constitutional example of the radio communication device (portable communication terminal) of the present invention.

FIG. 17 is a transition diagram of operational state for explaining the operation of a conventional portable communication device (portable telephone).

### EXPLANATION OF REFERENCE NUMERALS

1: radio communication device (portable communication terminal), 2: pager receiver, 3: cellular radio unit, 4: controller, MSCk, MSCk+1, MSCk+2: control station, 11k, 11k+1, 11k+2: pager central station section, 12k, 12k+1, 12k+2: cellular control station section, 13k, 13k+1, 13k+2: pager base station, BS: cellular base station.

### BEST MODE FOR CARRYING OUT THE INVENTION

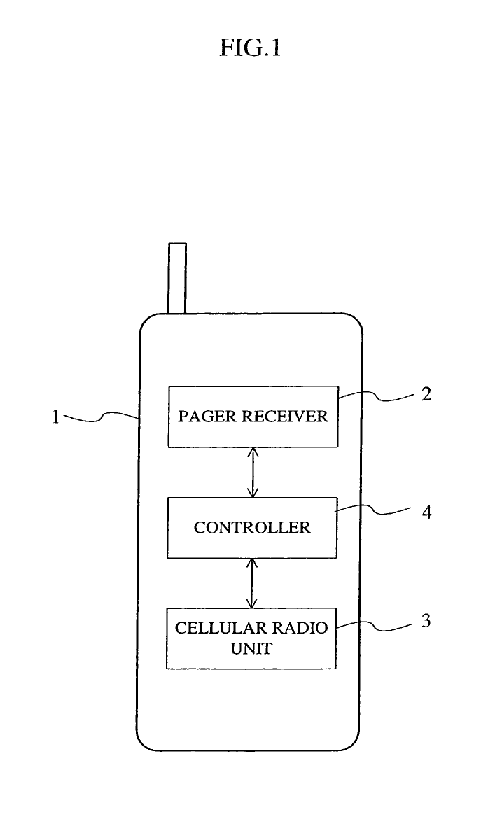

As shown in FIG. 1, a radio communication device (portable communication terminal) 1 according to the present invention includes a receiver 2 for a pager communication system (pager receiver), a radio set 3 for a cellular communication system (cellular radio unit), and a controller 4 for controlling the radio communication device 1 as a whole and controlling on/off of power supplies for the pager receiver 2 and the cellular radio unit 3. The radio communication device 1 is configured to turn on the power supply of the cellular radio unit 3 in response to a signal transmitted through the pager communication system.

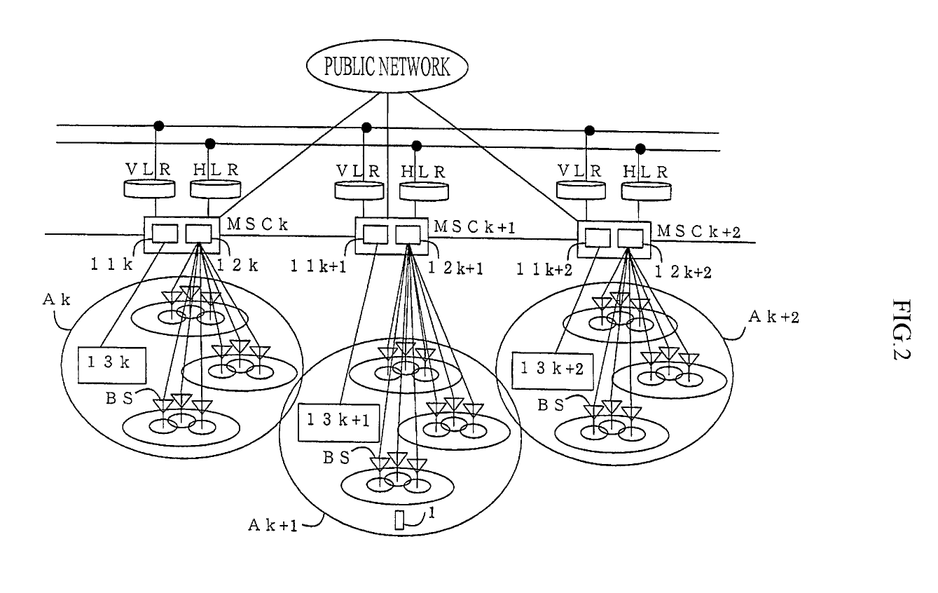

FIG. 2 is a view showing a schematic constitution of the entire radio communication system including the radio communication control station apparatus of the present invention. In FIG. 2, the reference numeral 1 indicates the radio communication device (portable communication terminal) of the present invention containing the above-described pager receiver 2 and cellular radio unit 3.

MSCk, MSCk+1, and MSCk+2 denote control stations. The control stations are provided with pager central station sections 11k, 11k+1, and 11k+2 functioning as central stations of the pager communication system (paging) and control station sections 12k, 12k+1, and 12k+2 of a cellular communication system functioning as control stations of the cellular communication system, respectively. The control stations MSCk, MSCk+1, and MSCk+2 correspond to pager communication system areas Ak, Ak+1, and Ak+2, respectively. Moreover, the control stations MSCk, MSCk+1, and MSCk+2 are connected to a public network.

The pager central station sections 11k, 11k+1, and 11k+2 are connected to pager base stations 13k, 13k+1, and 13k+2, respectively, and the pager base stations 13k, 13k+1, and 13k+2 correspond to the pager communication system areas Ak, Ak+1, and Ak+2, respectively. Each of the pager communication system areas Ak, Ak+1, and Ak+2 is provided with a plurality of cellular base stations BS. Each of the control stations 12k, 12k+1, and 12k+2 of a cellular communication system is connected to the plurality of cellular base stations BS in each of the pager communication system areas Ak, Ak+1, and Ak+2.

Each of the control stations MSCk, MSCk+1, and MSCk+2 is provided with a visitor location register (VLR) for registering a location of the portable communication terminal 1 and a home location register (HLR) for registering user accounting information or the like. The VLR and the HLR are connected to each other and share information.

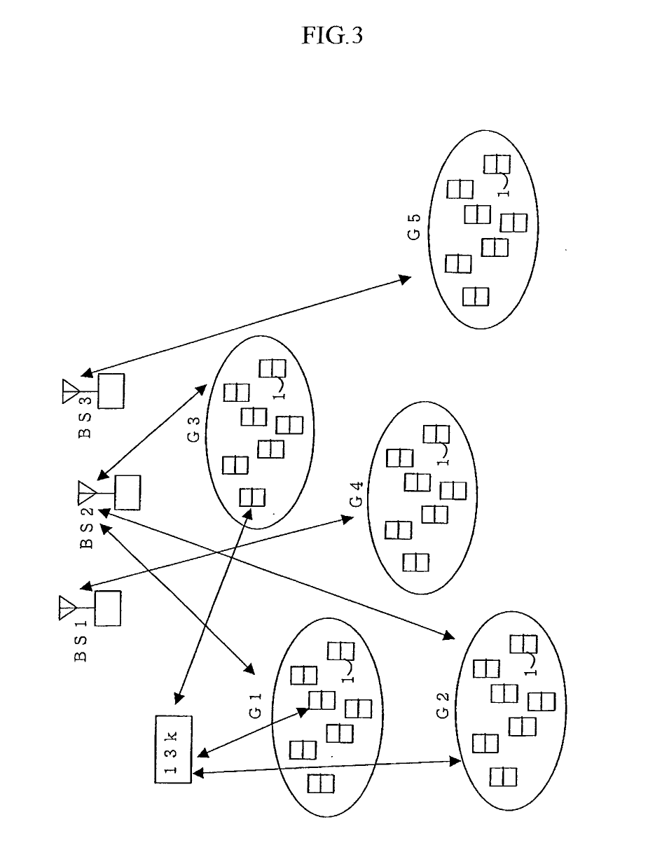

FIG. 3 shows the plurality of cellular base stations BS (BS1, BS2, BS3), the pager base station 13k, and groups G1, G2, G3, G4, and G5 of the plurality of portable communication terminals 1 in one pager communication system area Ak. In accordance with the embodiment, the plurality of portable communication terminals 1 are grouped like this. One telephone line and one pager communication line are assigned to one group. Therefore, the cellular radio units 3 in the plurality of portable communication terminals 1 contained in each group use the same telephone line. The pager receivers 2 in the plurality of portable communication terminals 1 contained in each group use the same pager number.

When the power supply of any one of the plurality of portable communication terminals 1 in a certain group is turned on, the control station MSCk registers location information of the portable communication terminal in the VLR. When another portable communication terminal 1 in the same group intends to start communication, the MSCk rejects the location registration thereof, and such rejection is displayed on a display unit of the portable communication terminal.

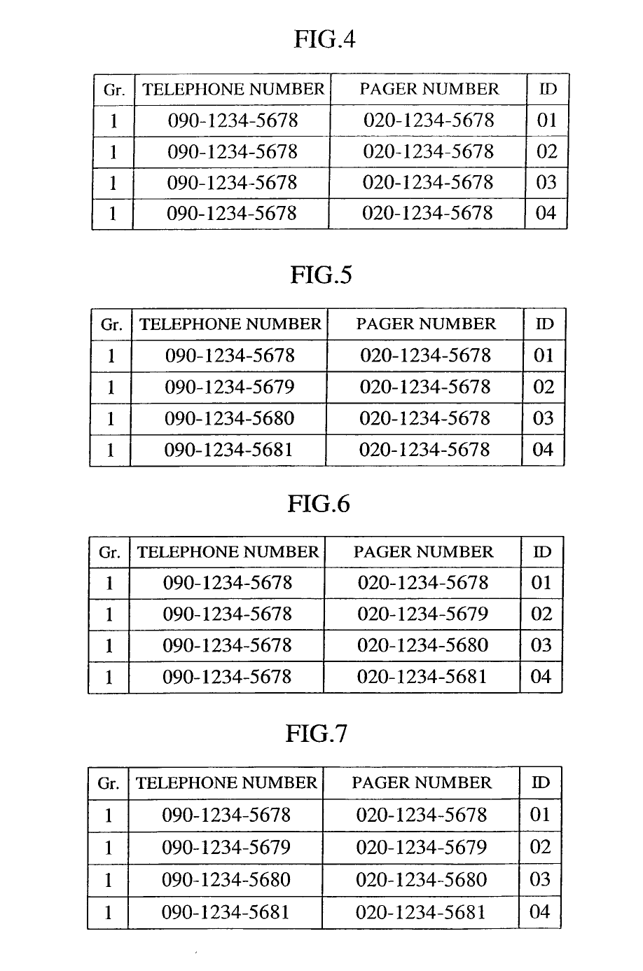

With reference to FIGS. 4 to 7, examples of the database registered in the HLR are shown. FIG. 4 shows a first example of information of the portable communication terminals registered in the HLR. In this example, all the portable communication terminals 1 in one group have the same cellular telephone number and pager number, and IDs different from each other are given to the portable communication terminals 1, respectively. FIG. 5 shows a second example of information of the portable communication terminals 1 registered in the HLR. In this example, all the portable communication terminals 1 in one group have cellular telephone numbers different from each other but the same pager number, and the IDs different from each other are given to the portable communication terminals 1, respectively. FIG. 6 shows a third example of information of the portable communication terminals 1 registered in the HLR. In this example, all the portable communication terminals 1 in one group have the same cellular telephone number but the pager numbers different from each other, and the IDs different from each other are given to the portable communication terminals 1, respectively. FIG. 6 shows a fourth example of information of the portable communication terminals 1 registered in the HLR. In this example, all the portable communication terminals 1 in one group have the cellular telephone numbers and the pager numbers different from each other, and the IDs different from each other are given to the portable communication terminals 1, respectively.

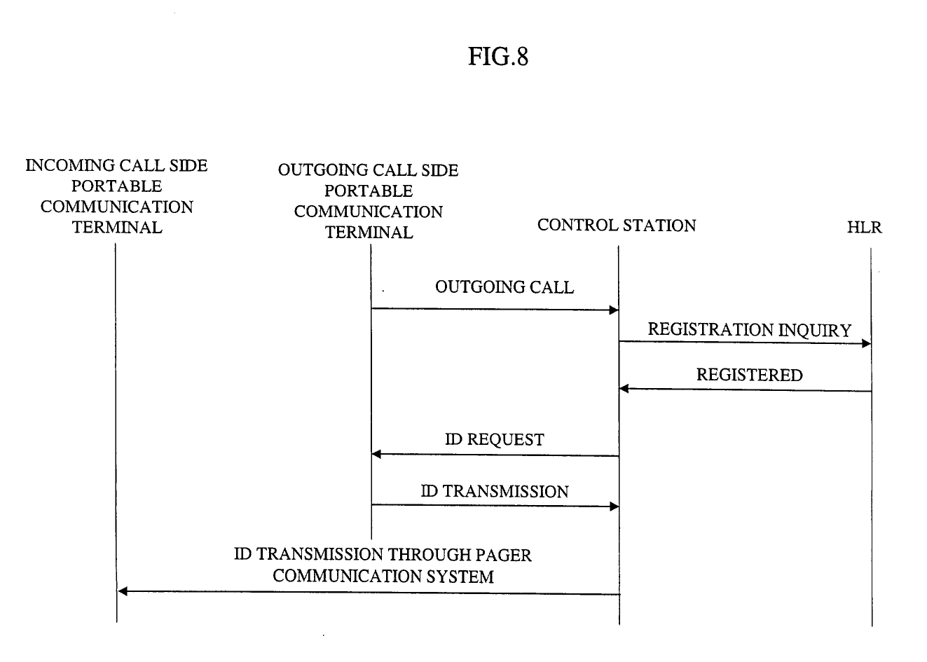

Referring to FIG. 8, description will be made on a connection of the portable communication terminal of the embodiment with regard to the first example of FIG. 4 and the third example of FIG. 6. When an outgoing call is made from a portable communication terminal on an outgoing call side to the cellular radio unit 3 of the portable communication terminal 1 of the embodiment shown in FIG. 4 or 6, the control stations MSCk, MSCk+1, and MSCk+2 inquire from the HLR whether or not the cellular telephone number of an incoming call party is registered as information of the grouped portable communication terminal as shown in FIG. 4 or 6. When the cellular telephone number of the incoming call party is not registered as being grouped in the HLR, the portable communication terminal of the incoming call party is determined to be a usual cellular portable communication terminal and processing is performed as such.

When the cellular telephone number of the incoming call party is registered as being grouped in the HLR, the control stations MSCk, MSCk+1, and MSCk+2 request the ID of the portable communication terminal 1 of the incoming call party from the outgoing call party. In the example in FIG. 4 or 6, since all the cellular telephone numbers are the same in the group, the control stations MSCk, MSCk+1, and MSCk+2 cannot request a connection of one cellular radio unit 3. Accordingly, the control stations MSCk, MSCk+1, and MSCk+2 request the ID of the incoming call party from the outgoing call party, and request a connection from the portable communication terminal 1 by means of the ID.

The control stations MSCk, MSCk+1, and MSCk+2 are previously connected to the pager receiver 2 of the portable communication terminal 1 of the incoming call party through the pager communication system. In the example of FIG. 4, since all the pager numbers are the same in the group, the control stations MSCk, MSCk+1, and MSCk+2 are connected to the pager receiver 2 of the incoming call party based on the ID received from the outgoing call party. The connected portable communication terminal 1 turns on the power supply of the cellular radio unit 3. In the example of FIG. 6, since the pager numbers are different in the group, the control stations MSCk, MSCk+1, and MSCk+2 specify the pager number based on the ID received from the outgoing call party, and are connected to the pager receiver 2 of the specified portable communication terminal 1. The portable communication terminal 1 turns on the power supply of the cellular radio unit 3. Thereafter, in both examples of FIGS. 4 and 6, the control stations MSCk, MSCk+1, and MSCk+2 are connected to the cellular radio unit 3 of one portable communication terminal 1 based on the ID of the incoming call party received from the outgoing call party.

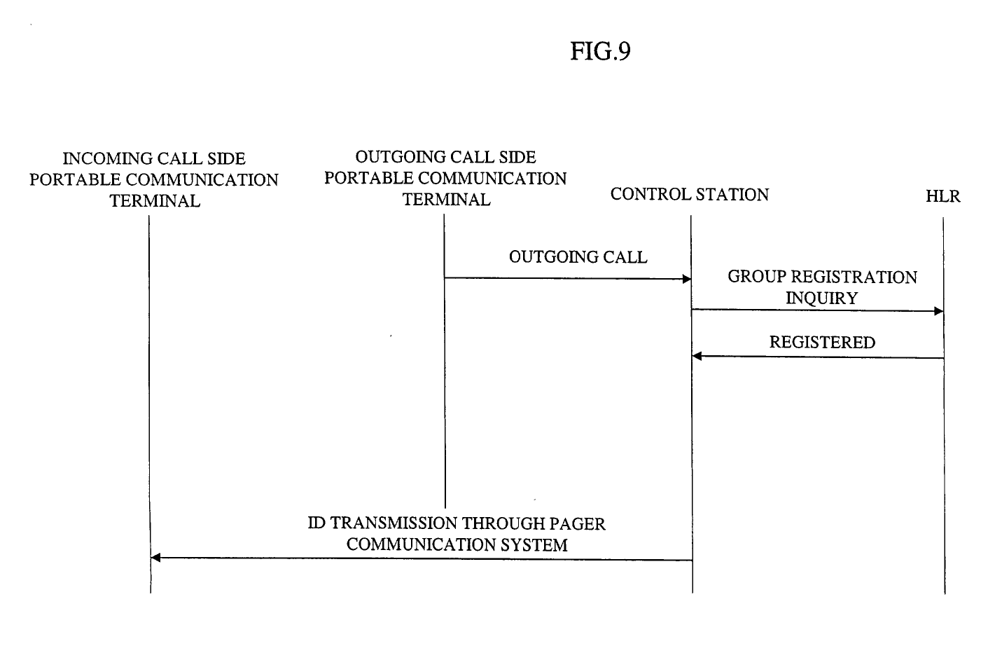

Referring to FIG. 9, description will be made on a connection of the portable communication terminal of the embodiment with regard to the second example of FIG. 5 and the fourth example of FIG. 7. When an outgoing call is made from the portable communication terminal on the outgoing call side to the cellular radio unit 3 of the portable communication terminal 1 of the embodiment shown in FIG. 5 or 7, the control stations MSCk, MSCk+1, and MSCk+2 inquire from the HLR whether or not the cellular telephone number of the incoming call party is registered as information of the grouped portable communication terminal as shown in FIG. 5 or 7. When the cellular telephone number of the incoming call party is not registered as being grouped in the HLR, the portable communication terminal of the incoming call party is determined to be a usual cellular portable communication terminal and processing is performed as such.

When the cellular telephone number of the incoming call party is registered as being grouped in the HLR, since all the cellular telephone numbers are different in the group in the example of FIG. 5, the control stations MSCk, MSCk+1, and MSCk+2 produce the ID based on the cellular telephone number. In the example of FIG. 7, since all the cellular telephone numbers and all the pager numbers are different in the group, the control stations MSCk, MSCk+1, and MSCk+2 can identify the portable communication terminals 1 one by one without using the IDs.

The control stations MSCk, MSCk+1, and MSCk+2 are previously connected to the pager receiver 2 of the portable communication terminal 1 of the incoming call party through the pager communication system. In the example of FIG. 5, since all the pager numbers are the same in the group, the control stations MSCk, MSCk+1, and MSCk+2 are connected to the pager receiver 2 of the incoming call party based on the ID corresponding to the cellular telephone number. The connected portable communication terminal 1 turns on the power supply of the cellular radio unit 3. In the example of FIG. 7, since all the cellular telephone numbers and all the pager numbers are different in the group, the control stations MSCk, MSCk+1, and MSCk+2 specify the pager number based on the cellular telephone number, and is connected to the pager receiver 2 of the specified portable communication terminal 1. The portable communication terminal 1 turns on the power supply of the cellular radio unit 3. Thereafter, in both examples of FIGS. 5 and 7, the control stations MSCk, MSCk+1, and MSCk+2 are connected to the cellular radio unit 3 of one portable communication terminal 1 based on the cellular telephone number.

Next, description will be made on the connection of the cellular radio unit 3 of the radio communication device (portable communication terminal) 1 of the incoming call party. In the embodiment, the cellular communication system and the pager communication system are used together, so that the pager communication system where the number of users has been significantly decreased can be efficiently utilized.

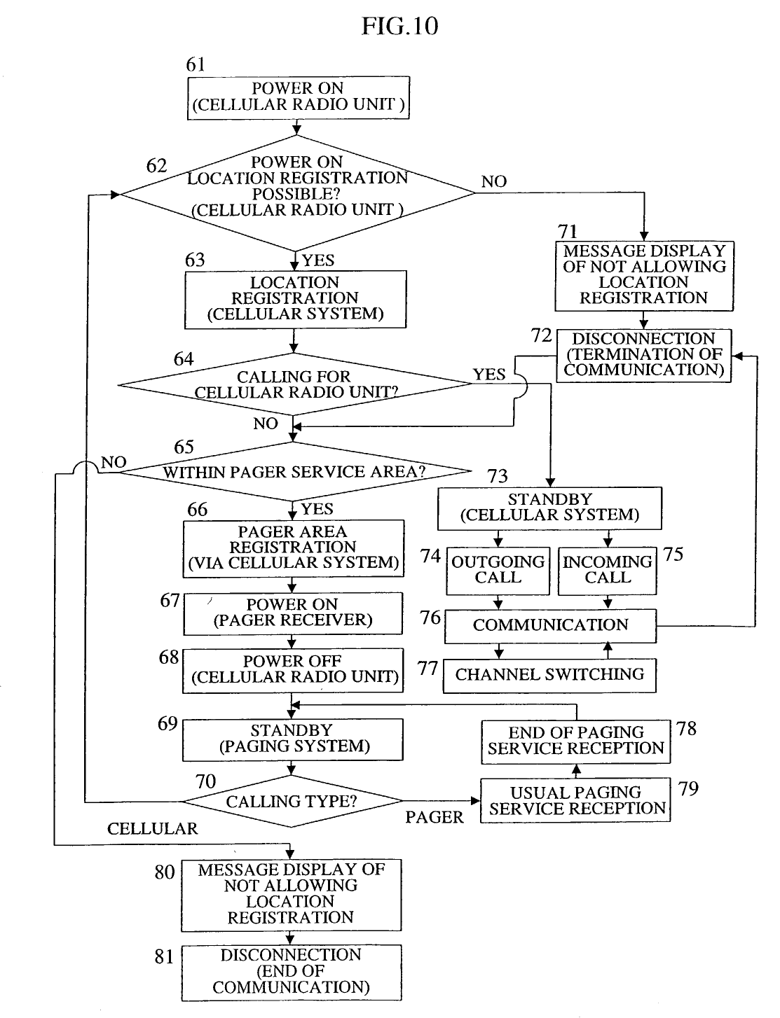

As shown in FIG. 10, when the operation of the radio communication device 1 according to the present invention is started, first, the power supply of the cellular radio unit 3 is turned on (61), and it is judged whether or not the location registration in the cellular communication system is possible (62). If communication of another radio communication device 1 in the same group has been already established, the new location registration is not allowed. In such a case, a message that the location registration is not allowed is displayed on a display unit 56 of the radio communication device 1 (71), and the communication is terminated.

When the location registration is allowed, the location registration is performed (63), and it is judged whether or not there is a calling for the cellular radio unit through the pager communication system (64). Immediately after the power supply is turned on, the result of the judgment is no.

Subsequently, it is judged whether or not a current location is within a service area of the pager communication system (65). Such judgment is performed by referring to a correspondence table between areas in the pager communication system and cells in the cellular communication system, which is stored in a ROM or EEPROM.

As a result of the judgment, when the current location is not within the service area of the pager communication system, a message that the location registration is not allowed is displayed on the display unit 56 (80), and then the power supply is turned off (81).

After termination of the communication (72), the procedure is returned to the judgment whether or not the current location is within the service area of the pager communication system (65).

On the other hand, when the current location is within the service area of the pager communication system, area registration for the pager communication system is performed (66). The area registration is performed via the cellular radio unit 3 through the cellular communication system. Specifically, the controller 4 supplies an area registration signal for the pager central station section 11k to the cellular radio unit 3, and transmits the same via the cellular radio unit 3. Notice of the area registration signal received by the cellular base station and transmitted to the control station section 12k of a cellular communication system is given to the pager central station section 11k from the control station section 12k of a cellular communication system. Thus the area registration of the pager communication system is automatically performed through the cellular communication system.

In the above description, the area registration is performed by transmitting the area registration signal to the central station of the pager communication system from the portable communication terminal 1. However, the area registration may be automatically performed in the control station MSCk by means of the stored correspondence table indicating the correspondence relationship between the areas of the pager communication system and the cells of the cellular communication system. Specifically, when the location registration (63) of the pager receiver is performed, the pager number may be automatically registered in the area corresponding to the cell in which the location is registered (63) with reference to the correspondence table between the areas and the cells and the correspondence table between the telephone numbers, the pager numbers, and the IDs.

Next, the power supply of the pager receiver is turned on (66), and the power supply of the cellular radio unit is shut off (68). The portable communication terminal 1 becomes a standby mode of the pager communication system (69).

In the standby mode (69), when an incoming call is received through the pager communication system, a type of the calling (a type of the message) is determined (70). When the incoming call is a calling of a usual paging service, reception of the usual paging service is performed (79). After termination of the reception (78), the portable communication terminal 1 is shifted to the standby mode of the pager communication system (69). On the other hand, when the incoming call is a calling for the cellular radio unit (request for reception of the cellular radio unit, message for instructing to turn on the power supply of the cellular radio unit 3), the power supply of the cellular radio unit 3 is turned on (61), and the location registration is performed (63), if possible. When the incoming call is a calling for the cellular radio unit (64), the portable communication terminal 1 is shifted to a standby mode of the cellular communication system (73). Then the portable communication terminal 1 receives the simultaneous calling channel, and receives the incoming call signal for the portable communication terminal 1 itself (75). After transmitting a response signal to the incoming call, the portable communication terminal 1 performs communication through an assigned communication channel (76). Channel switching is performed when necessary (77). After termination of the communication (72), the procedure is returned to the judgment (65) whether or not the current location is within the service area of the pager communication system.

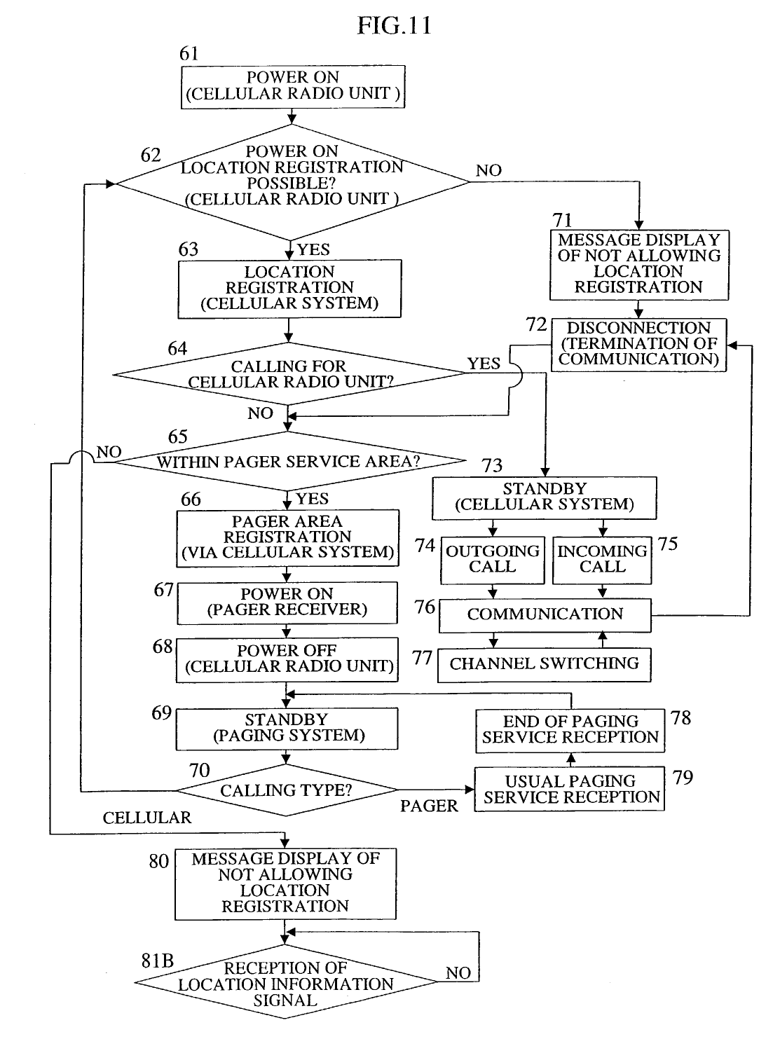

In FIG. 10, when the portable communication terminal 1 is not located within the service area in step 65, the message is displayed (80), and the communication is terminated (81). However, as shown in FIG. 11, after the similar message is displayed (80), the portable communication terminal may wait for reception (81B) while intermittently receiving the location information signal from the pager base station (13k, etc.). When the location information data is received, the procedure is returned to step (66), followed by processing similar to that in FIG. 10.

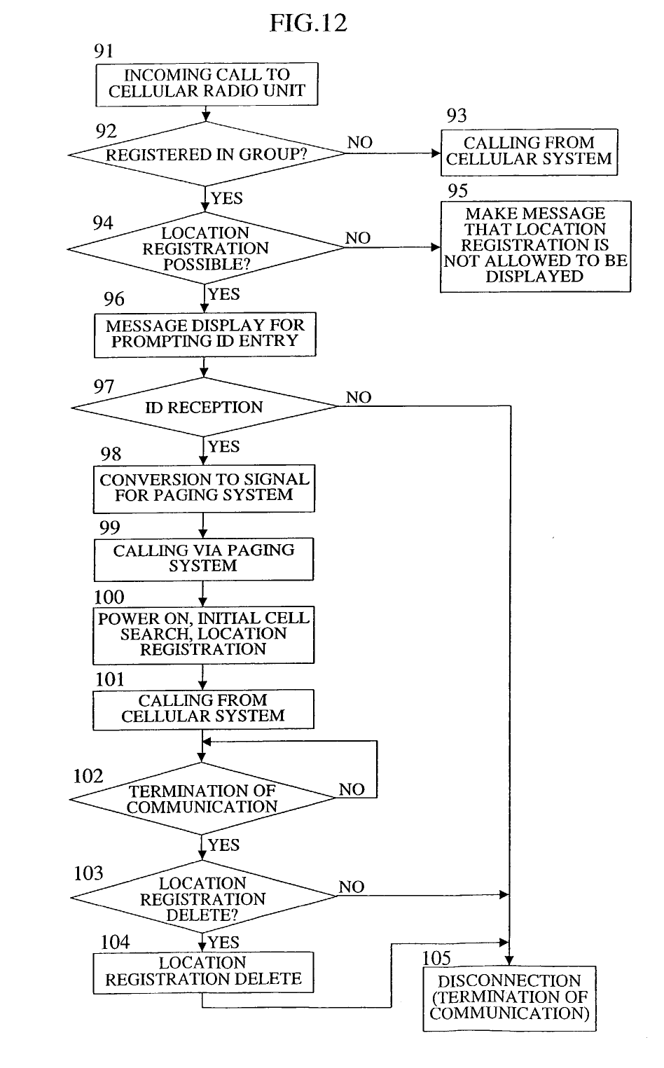

As shown in FIG. 12, in the control station MSCk, when an incoming call for the cellular radio unit is received (91), it is judged whether or not the cellular radio unit has been registered in the group (FIGS. 4 to 7) (92). As described above, the radio communication device 1 according to the present invention is configured to automatically perform the area registration in a service area of the pager communication system through the cellular communication system when located within the service area of the pager communication system. Accordingly, in the control station MSCk, the pager number corresponding to the called telephone number is known with reference to the correspondence table between the pager numbers and the telephone numbers and it is judged whether or not the area of the pager receiver is registered in the pager communication system by the pager central station section 11k. On the other hand, when the pager receiver having the number corresponding to the called telephone number is not registered in the group, processing is performed similarly to the case of the incoming call in the usual cellular communication system (93).

When the pager receiver is registered in the group, it is judged whether or not the location registration of the telephone number to the VLR is possible (94). As explained in relation to FIG. 3, when the location registration of another portable communication terminal in the same group has been already performed, the location registration is not allowed. When the location registration is not allowed, a message that the location registration is not allowed is displayed on a communication apparatus of the outgoing call party (95). When the location registration is allowed, in the examples of FIGS. 4 and 6, a plurality of portable communication terminals exist for the same telephone number, and the portable communication terminal must be specified by means of the ID, so that the control station displays a message for prompting entry of the ID in the outgoing call party (96). When the ID is inputted in response to the message and the control station MSCk receives the inputted ID (97), the control station MSCk converts the incoming call signal for the cellular radio unit to a signal for the pager communication system (an address signal of the corresponding receiver and a message for instructing to turn on the power supply of the cellular radio unit 3) (98), and performs calling through the pager communication system. Specifically, the pager central station section 11k transmits information indicating the occurrence of the incoming call for the cellular radio unit (alternatively, a message for instructing to turn on the power supply of the cellular radio unit 3) to the pager receiver corresponding to the called cellular radio unit through the paging base station 13 (99). Thereby the power supply of the cellular radio unit 3 of the portable communication terminal 1 is turned on, and the cellular radio unit 3 performs the initial cell search and the location registration to start reception of the simultaneous calling channel (100). In the examples of FIGS. 5 and 7, since the telephone numbers of the portable communication terminals are different from each other, the ID can be produced from the database. Accordingly, steps 96 and 97 are unnecessary.

Next, the control station section 12k of the cellular communication system also performs calling of the cellular radio unit through the simultaneous calling channel of the cellular communication system (101).

Accordingly, the cellular radio unit 3 receives the simultaneous calling channel to receive the incoming call signal for the cellular radio unit 3 itself, and to perform communication.

Thereafter, termination of the communication is monitored (102). When the communication is terminated, it is judged whether or not the location registration must be deleted (103). If the location registration of the portable communication terminal which has been once registered is remained intact, the location registration of another portable communication terminal in the same group cannot be performed. Therefore, in order to increase the frequencies of use of all the portable communication terminals in the group, the location registration may be preferably deleted immediately after the termination of the communication. However, when the location registration is retained, it is advantageous that connecting process is rapidly performed when the same portable communication terminal is continuously used. Note that when the location registration is retained and an outgoing/incoming call from/to another portable communication terminal occurs, the portable communication terminal having the location registered may be notified of the occurrence of the outgoing/incoming call from/to another terminal through the pager communication system, and may be asked to turn off the power supply.

Here, it is set previously whether or not the location registration is to be deleted by a user or a communication service company. When the location registration should be deleted, delete processing of the location registration is performed (104).

Among the portable communication terminals in one group, one preferential portable communication terminal (hereinafter, referred to as a preferential terminal) may be determined, and for the preferential terminal, the location registration may be retained unless the power supply thereof is turned off. For example, in a family, when the portable communication terminal of mother is set as the preferential terminal, the mother can control use of the portable communication terminals of the other family members. The mother may turn off the power supply of the preferential terminal, only when the mother allows the other family members to use the portable terminals.

Furthermore, when the location registration of such a preferential terminal is made, the preferential terminal may be notified of the outgoing/incoming call from/to another portable communication terminal through the pager communication system, and may be asked for permission (turning off of the power supply of the preferential terminal).

In the above-described operation of the control station shown in FIG. 12, at the time of calling the cellular radio unit 3 through the pager communication system, the control station just turns on the power supply of the cellular radio unit 3. Next, description will be made on an embodiment, in which the control station transmits paging information necessary for the cellular radio unit 3 in addition to the above-described message through the pager communication system.

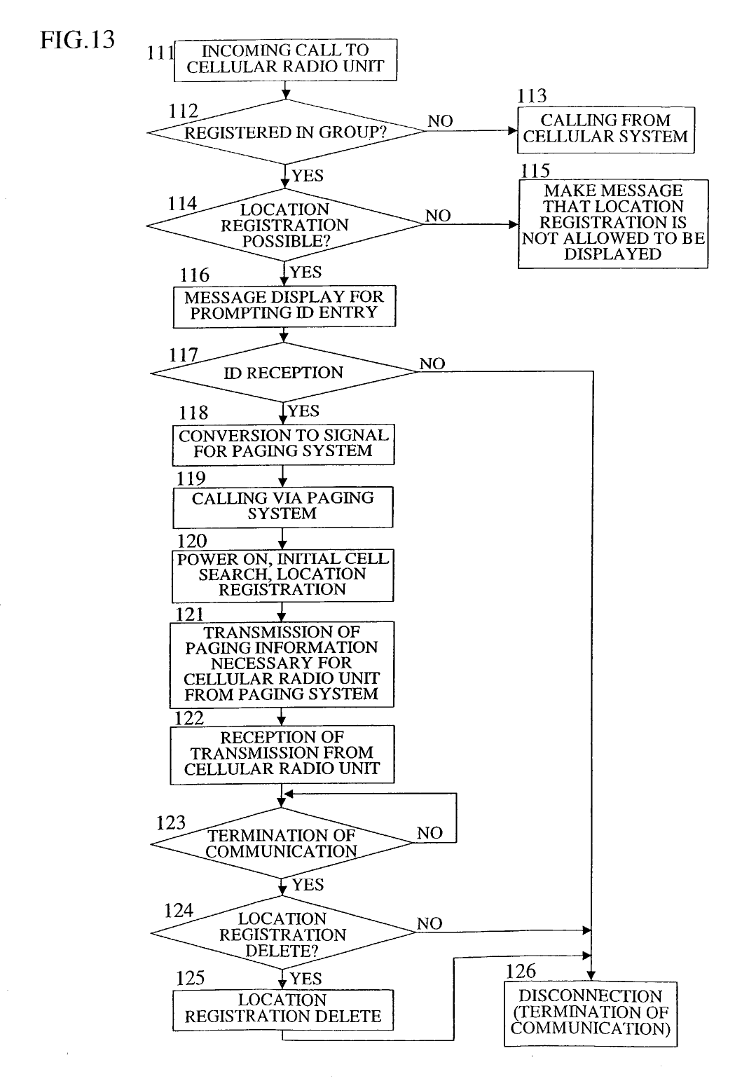

FIG. 13 is a flowchart showing an operational flow of the control part in another embodiment.

As shown in FIG. 13, in the control station MSCk, when an incoming call for the cellular radio unit 3 is received (111), it is judged whether or not the cellular radio unit 3 is registered in the group (112). When the cellular radio unit 3 is not registered in the group, processing is performed as same as the case of the incoming call in the usual cellular communication system (113).

When the cellular radio unit 3 is registered in the group, it is judged whether or not the location registration of the telephone number thereof to the VLR is allowed (114). Similarly to FIG. 12, when the location registration of another portable communication terminal in the same group has been already performed, the location registration is not allowed. When the location registration is not allowed, a message that the location registration is not allowed is displayed in the communication apparatus of the outgoing call party (115). When the location registration is allowed, in the examples of FIGS. 4 and 6, the plurality of portable communication terminals exist for the same telephone number, and the portable communication terminal should be specified by means of the ID. Accordingly, the control station displays a message for prompting entry of the ID in the outgoing call party (116). When the ID is inputted in response and the control station MSCk receives the inputted ID (117), the control station MSCk calls the cellular radio unit 3 through the pager communication system (118, 119). Accordingly, the power supply of the cellular radio unit 3 of the portable communication terminal 1 is turned on and the cellular radio unit 3 performs the initial cell search and the location registration to start reception of the simultaneous calling channel (120). In the examples of FIGS. 5 and 7, since the telephone numbers of the portable communication terminals are different from each other, the ID can be produced from the database. Accordingly, steps 116 and 117 are unnecessary.

This embodiment is similar to the embodiment shown in FIG. 12 so far. However, in this embodiment, after calling the cellular radio unit 3 by transmitting the message for instructing to turn on the power supply of the cellular radio unit 3 (119), the control station transmits the paging information necessary for the cellular radio unit 3 as a message of the pager communication system (121). The paging information is transmitted from the pager receiver 2 to the controller 4. Accordingly, it becomes unnecessary that the cellular radio unit 3 receives the simultaneous calling channel. Furthermore, by referring to the correspondence table between the areas of the pager communication system and the cells of the cellular communication system, a range of the initial cell search of the cellular radio unit 3 can be narrowed, thereby enabling rapid cell search.

After the transmission of the paging information necessary for the cellular radio unit 3 through the cellular communication system in step 121, the control station section 12k of a cellular communication system waits for a response signal from the cellular radio unit 3 to receive the same (122), and subsequently shifts to the communication channel for communication in the cellular communication system.

Thereafter, termination of the communication is monitored (123). When the communication is terminated, it is judged whether or not the location registration must be deleted (124). If the location registration of the portable communication terminal which has been once registered is remained intact, the location registration of another portable communication terminal in the same group cannot be performed. Therefore, in order to increase the frequencies of use of all the portable communication terminals in the group, the location registration may be preferably deleted immediately after the termination of the communication. However, when the location registration is retained, it is advantageous that connecting process is rapidly performed when the same portable communication terminal is continuously used.

Note that when the location registration is retained and an outgoing/incoming call from/to another portable communication terminal occurs, the portable communication terminal having the location registered may be notified of the occurrence of the outgoing/incoming call from/to another terminal through the pager communication system, and may be asked to turn off the power supply.

Here, it is set previously whether or not the location registration is to be deleted by a user or a communication service company. When the location registration should be deleted, delete processing of the location registration is performed (125).

Similarly to FIG. 12, among the portable communication terminals in one group, one preferential portable communication terminal (hereinafter, referred to as a preferential terminal) may be determined, and for the preferential terminal, the location registration may be retained unless the power supply is turned off. Moreover, when the location registration of the preferential terminal is made, the preferential terminal may be notified of an outgoing/incoming call from/to another portable communication terminal through the pager communication system, and may be asked for permission (turning off the power supply of the preferential terminal).

As described above, in the radio communication system according to the present invention, when the portable communication terminal is located within the service area of the pager communication system after the power supply thereof is turned on, the area registration is performed for the pager communication system, and only the pager receiver is operated by shutting off the power supply of the cellular radio unit. Thus the standby operation of the pager communication system is substituted for the standby operation of the cellular communication system. Therefore, the power consumption at the standby mode of the radio communication device 1 can be greatly reduced.

Moreover, while the frequency of the location registration to the cellular communication system can be decreased, the expense per one portable communication terminal can be reduced. The system efficiency can be enhanced, and moreover, the pager communication system can be efficiently utilized.

Furthermore, it becomes possible that the area registration of the pager communication system is automatically performed through the cellular communication system, so that necessity of the area registration to the pager communication system by the user can be eliminated.

In the above description, the occurrence of the incoming call for the cellular radio unit 3 is reported by transmission of the message for instructing to turn on the power supply of the cellular radio unit 3 through the pager communication system. However, the reporting manner is not limited to this, and a command or a certain code for reporting occurrence of an incoming call for the cellular radio unit 3 may be predetermined and used for reporting the occurrence of the incoming call for the cellular radio unit 3.

In the above description, the power supply of the pager receiver is turned on (steps 66 and 67 in FIGS. 10 and 11) after the area registration to the pager communication system, and thereafter, the power supply of the pager receiver is made to always be on. However, in order to avoid noise, only one of the pager receiver and the cellular radio unit may be allowed to operate at a time.

Furthermore, as described above, in a case that there is an incoming call for the cellular radio unit and the cellular radio unit is required to be called through the pager communication system, when the cellular radio unit 3 cannot perform communication for the reason that another cellular radio unit in the same group is in use, or the reason that no idle channel is remained, the arrival of the call can be displayed on the display unit.

In the above-described radio communication system, the processing in the control station MSCk is necessary. Here, description will be made on another embodiment according to the present invention, which does not require the processing in the control station MSCk and can be carried out by only a terminal company. In this case, the control station MSCk provided with the pager central station section 11k and the control station section 12k of a cellular communication system as described above is not required, and the embodiment can be applied to the current existing pager communication system and cellular communication system. The communication apparatus (telephone or portable phone) is equipped with a function for transmitting to the pager a telephone number (cellular radio unit number), information indicating whether or not the cellular radio unit is the radio communication device according to the present invention having the pager receiver mounted, the corresponding pager number, telephone directory information having IDs recorded, and the message instructing the radio communication device 1 according to the present invention to turn on the power supply of the cellular radio unit 3.

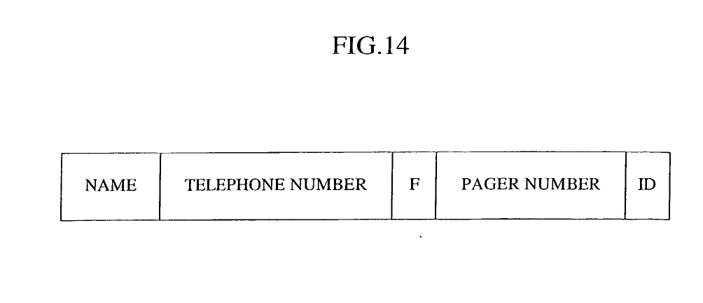

FIG. 14 is a chart showing a format example of one record of the telephone directory information. As shown in the chart, a cellular radio unit number (telephone number), a flag F indicating whether or not the pager receiver is mounted, a pager number, and an ID are stored by a name.

The operation of the radio communication device 1 of the embodiment may be substantially the same as those in the state transition diagrams shown in FIGS. 10 and 11. However, the area registration to the pager communication system by the control station MSCk is not performed.

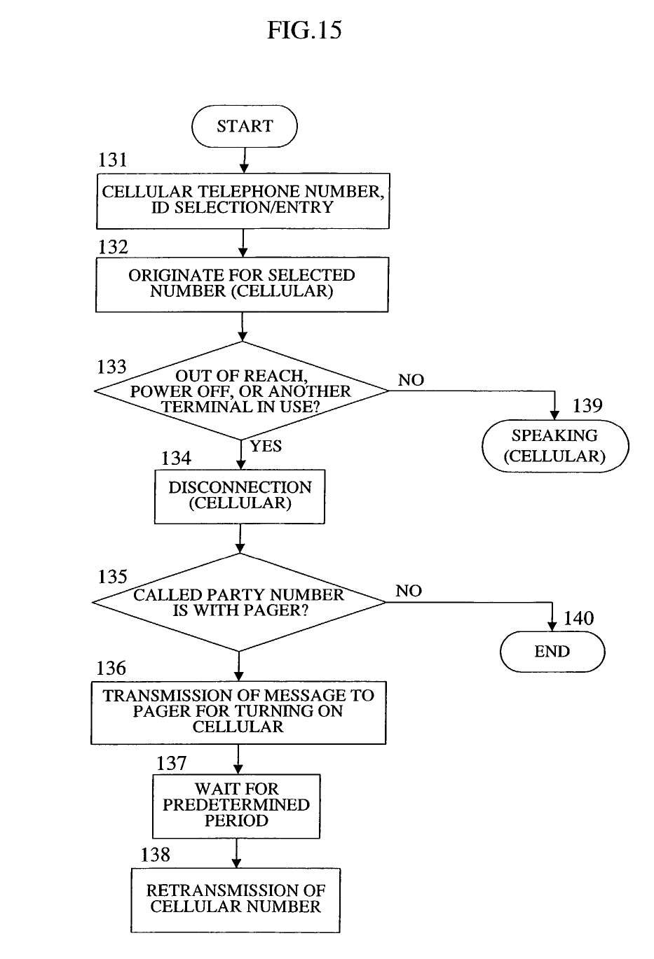

FIG. 15 is an operational flowchart at the time of originating a call for the cellular radio unit in the communication apparatus according to the present invention configured in such a manner.

The cellular number and the ID are selected from the telephone directory information stored in the communication apparatus or are directly inputted (131), so that a call is originated for the cellular radio unit (132). As a result, when a message that communication cannot be performed is displayed in such a case that it is located out of reach, a case that the power supply is off, a case that another portable communication terminal 1 in the same group is in use, or the like, the originated call is disconnected (134). On the other hand, when such a message is not received, speaking is carried out as in the usual case (139). In the examples in FIGS. 5 and 7, since the telephone numbers of the portable communication terminals are different from each other, the ID can be produced from the database. Accordingly, the input of the ID in step 131 is unnecessary.

After the disconnection for the cellular radio unit is performed in the step 134, it is judged whether or not the cellular telephone number is a telephone number of the radio communication device 1 according to the present invention, to which the pager receiver is mounted, with reference to the telephone directory information (135). As a result, when the cellular telephone number is the telephone number for the portable communication terminal to which the pager receiver is not mounted, the procedure is then terminated (140).

On the other hand, when the corresponding pager number is stored, the communication apparatus transmits the message instructing to turn on the power supply of the cellular radio unit 3 to the pager telephone number (136). Accordingly, as explained with regard to FIGS. 10 and 11, the power supply of the cellular radio unit 3 is turned on, and the cellular radio unit 3 is set in the standby mode.

After instructing to turn on the power supply of the cellular radio unit 3 of the party in the step 136, the communication apparatus waits for a predetermined period of time corresponding to a period of time until the cellular radio unit 3 is switched into a stand-by mode (137), and then a call is originated for the cellular radio unit apparatus 3 again (138). Accordingly, even when the power supply of the cellular radio unit 3 of the radio communication device 1 according to the present invention is off, the speech can be carried out. If the communication is not allowed, e.g. in such a case that the radio communication device 1 is located out of reach, the processing is terminated after steps 132 to 138 in FIG. 15 are repeated a predetermined times.

When the communication apparatus according to the present invention is used as described above, like the above described radio communication system, the power consumption of the portable communication terminal at the standby mode can be reduced without any special control stations provided.

Note that the telephone directory information is not limited to the one exemplified in FIG. 14, but any information may be used as long as it has at least the cellular radio unit number, the corresponding pager receiver number, and the ID recorded.

Furthermore, in the radio communication system according to the present invention, by managing the frequency of use of each portable communication terminal, and providing messages or the like to the users, alternatively performing use restriction thereof properly so that the frequencies of use of the portable communication terminals are made to be uniform in each group, the communication service can be made further appropriate. Moreover, a service may be performed, which prompts the group or the portable communication terminal which are frequently used to acquire an independent telephone number.

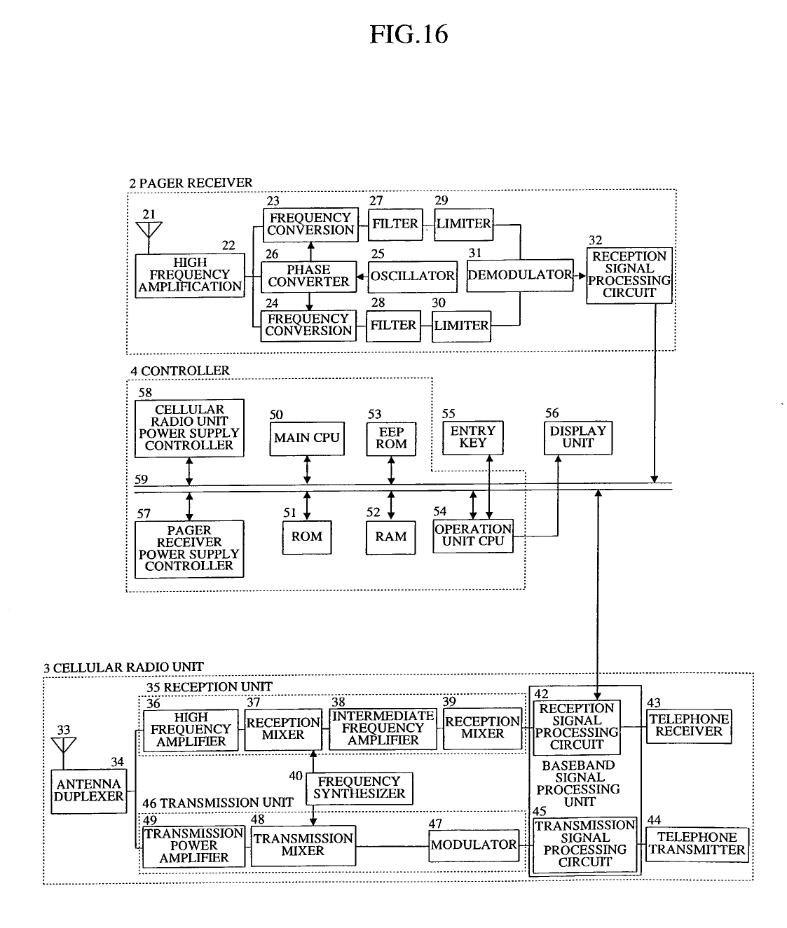

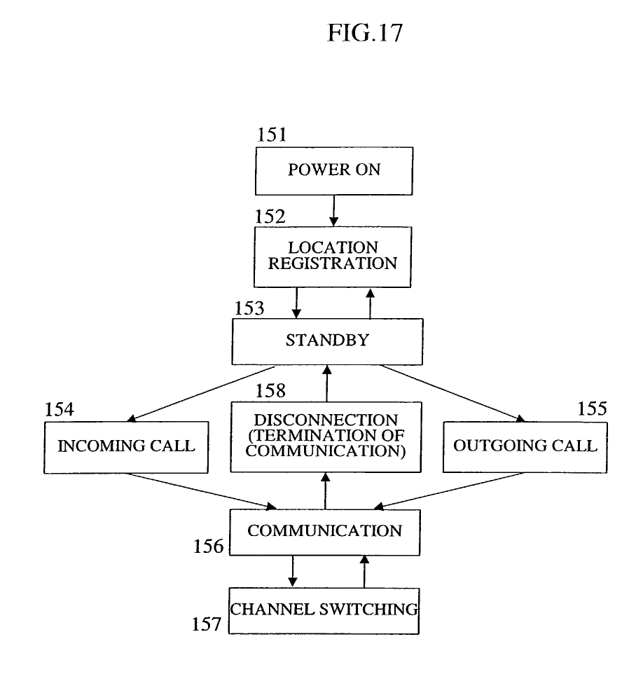

Referring to FIG. 16, description will be made in detail on a constitution of the radio communication device 1 according to the present invention. A signal from the pager base station, which has been received by an antenna 21 of the pager receiver 2, is amplified by the high frequency amplifier 22, split into two paths, and inputted into frequency converters 23 and 24. Local oscillation signals, which are different in phase by 90 degrees and have a frequency equal to a carrier signal frequency from an oscillator 25, are supplied to the frequency converters 23 and 24 via a phase converter 26. Outputs converted to the baseband in the frequency converters 23 and 24 are respectively inputted into a demodulator 31 via filters 27 and 28 and limiters 29 and 30 for demodulation. The demodulated signal is supplied to a reception signal processing circuit 32. When an address signal of its own is detected, a message signal thereof is supplied to the controller 4. In the case that the message signal is a usual reception message in the pager communication system, the message is displayed on the display unit 56. In the case of the message for instructing to turn on the power supply of the cellular radio unit 3, the power supply of the cellular radio unit 3 is turned on by a cellular radio unit power supply controller 58 in the controller 4. Here, as the pager receiver 2, a direct conversion type receiver as described above is employed. However, a superheterodyne type receiver may also be employed.

In the cellular radio unit 3, a signal from the cellular base station, which has been received by an antenna 33, is inputted into a reception unit 35 via an antenna sharing unit 34. After the signal is subjected to high-frequency amplification in a high frequency amplifier 36, the signal is inputted into a reception mixer 37. In the reception mixer 37, the signal is subjected to frequency conversion with a local oscillation signal from a frequency synthesizer 40, and is demodulated in a receiving mixer 39 after passing through an intermediate frequency amplifier 38. The demodulated reception signal for the cellular radio unit itself is subjected to signal processing in a reception signal processing circuit 42 of a baseband signal processing unit 41, and outputted to a telephone receiver 43. Alternatively, the signal is outputted to the display unit 56 via the controller 4.

On the other hand, an audio signal from a telephone transmitter 44 or an input data from the controller 4 is subjected to signal processing in a transmission signal processing circuit 45, and then inputted to the transmission unit 46. Specifically, an output signal from the transmission signal processing circuit 45 is subjected to predetermined modulation processing in a modulator 47, and then converted into a high frequency signal in a transmission mixer 48 by receiving a signal from the frequency synthesizer 40. Subsequently, the converted signal is amplified in the transmission power amplifier 49, and transmitted from the antenna 33 toward the cellular base station via the antenna sharing unit 34.

In the controller 4, the reference numeral 50 denotes a main central processing unit (main CPU) for controlling the radio communication device 1 as a whole, 51 denoting a ROM having a control program, a predetermined constant, or the like stored, 52 denoting a RAM used for a work area, 53 denoting an electrically erasable and programmable ROM (EEPROM) such as a flash memory for storing various types of parameters, tables, or the like, 54 denoting an operation unit CPU for performing a data output to entry keys 55 and the display unit 56, 57 denoting a pager receiver power supply controller for controlling turning on/off of the power supply of the pager receiver 2, and 58 denoting a cellular radio unit power supply controller for controlling on/off of the power supply of the cellular radio unit 3. These components and the reception signal processing circuit 32 of the pager receiver and the baseband signal processing unit 41 of the cellular radio unit are interconnected by a bus 59.

The controller 4 performs controls such as a control of the transmission/reception sequence operation in the pager receiver 2 and the cellular radio unit 3, modulation and demodulation of transmission and reception signals, and a control of transmission/reception protocols. In addition, as described above, the controller 4 performs controls of processing for displaying on the display unit 56 the reception message of the pager communication system, information received by the cellular radio unit, or various types of information for the operator, processing for displaying on the display unit 56 various types of information entered from the entry keys 55, processing for outputting the data entered from the entry keys 55 to the baseband signal processing unit 41 of the cellular radio unit, processing of the pager receiver power supply controller 57 and the cellular radio unit power supply controller 58, processing for turning on the power supply of the cellular radio unit 3 through the cellular radio unit power supply controller 58 at reception of the message instructing to turn on the power supply of the cellular radio unit 3, and the other operations of the entire radio communication device.

In the ROM 51 or the EEPROM 53, the correspondence table between the areas of the pager communication system and the cells of the cellular communication system (alternatively, location registration areas) is recorded.

As described above, the radio communication device 1 according to the present invention includes the pager receiver 2, the cellular radio unit 3, and the power supply controllers (57, 58) for controlling turning on/off of the power supplies thereof, and is configured to be capable of turning on the power supply of the cellular radio unit 3 in accordance with the message transmitted through the pager communication system. Accordingly, the standby operation can be performed by using only the pager receiver 2 of very little power consumption, and the power supply of the cellular radio unit 3 can be turned on if necessary, so that the power consumption at the standby mode can be greatly reduced.

Note that for the portable communication terminal 1, a PDA having a radio communication function, an embedded phone, and other radio communication device with telephone lines are included, and the portable communication terminal 1 is not limited to the above-described constitution.

Industrial Applicability

According to the present invention, the burden of expenses for the basic charge of a user who does not frequently use the portable communication terminal can be relieved and the pager communication system can be efficiently utilized.

1. A radio communication control station apparatus, comprising:
a memory for storing cellular telephone numbers of cellular radio units of a plurality of grouped radio communication devices together with respectively corresponding pager numbers of pager receivers;
pager calling means for calling a pager receiver for incoming call to the corresponding cellular telephone number stored in the memory; and
cellular calling means for calling a cellular radio unit of the cellular telephone number after the calling by the pager calling means.

2. The radio communication control station apparatus according to claim 1, wherein the memory stores the identical cellular telephone numbers and the identical pager numbers assigned for the plurality of radio communication devices in one group.

3. The radio communication control station apparatus according to claim 1, wherein the memory stores the different cellular telephone numbers and the identical pager numbers assigned for the plurality of radio communication devices in one group.

4. The radio communication control station apparatus according to claim 1, wherein the memory stores the identical cellular telephone numbers and the different pager numbers assigned for the plurality of radio communication devices in one group.

5. The radio communication control station apparatus according to claim 1, wherein the memory stores the different cellular telephone numbers and the different pager numbers assigned for the plurality of radio communication devices in one group.

6. The radio communication control station apparatus according to claim 1, further comprising:
location registration means for registering location information of one of the cellular radio units being grouped and stored in the memory, when an outgoing call to or an incoming call from the cellular radio unit occurs, and when the location information of another cellular radio unit in a group to which the cellular radio unit belongs is not registered.

7. The radio communication control station apparatus according to claim 6, wherein said location registration means deletes registration of the location information when communication of the cellular radio unit is terminated.

8. The radio communication control station apparatus according to claim 6, wherein, in a state that location information has been registered by the location registration means, when an incoming call to or an outgoing call from another cellular radio unit in a same group occurs, the pager calling means notifies the cellular radio unit of which location information is registered of the occurrence of the incoming call or the outgoing call.

9. The radio communication control station apparatus according to claim 6, wherein, for one particular cellular radio unit (hereinafter, referred to as a preferential terminal) in the group, the location registration means retains registration of the location information until a power supply thereof is turned off after communication is terminated, and for the other cellular radio units (hereinafter, referred to as a non-preferential terminal), the location registration means deletes registration of the location information when the communication is terminated.

10. The radio communication control station apparatus according to claim 9, wherein, when an incoming call to or an outgoing call from the non-preferential terminal is received, the pager calling means notifies the preferential terminal of the incoming call or the outgoing call.

11. A plurality of radio communication devices having cellular radio units and pager receivers mounted thereon, wherein the cellular radio units have a same cellular telephone number, alternatively the pager receivers have a same pager number.
